(19) United States
(12) Patent Application Publication
(10) Pub. No.: US 2026/0022892 A1
(43) Pub. Date: Jan. 22, 2026

(54) SHELL AND TUBE HEAT EXCHANGERS

(71) Applicant: Enaxiom Pty Ltd., Sydney (AU)

(72) Inventor: Bijan Rahimi, Sydney (AU)

(73) Assignee: Enaxiom Pty Ltd., Sydney (AU)

(21) Appl. No.: 19/270,952

(22) Filed: Jul. 16, 2025

Related U.S. Application Data
(60) Provisional application No. 63/672,981, filed on Jul. 18, 2024.

(51) Int. Cl. F28D 3/02

(52) U.S. Cl. CPC F28D 3/02

(57) ABSTRACT

The present disclosure describes a falling film evaporator and various systems utilizing such evaporators.

### CROSS REFENCE TO RELATED APPLICATIONS

This application claims priority to U.S. Provisional Application No. 63/672,981, filed Jul. 18, 2024, which is herein incorporated by reference in its entirety.

### BACKGROUND OF THE DISCLOSURE

Shell and tube heat exchangers, such as falling film evaporators and shell and tube condensers, are frequently used as heating and cooling solutions in a wide variety of industrial applications, such as chemical manufacturing, mineral refineries, wastewater treatment, desalination plants, and others. These heat exchangers operate by flowing a fluid through various tubes in a bundle that reside within a larger shell and simultaneously flowing another fluid along the outside of the tubes. Such indirect thermal contact allows for the efficient facilitation of heat transfer between the two fluids.

However, due to their metal tubes and shells, shell and tube heat exchangers often face issues such as scaling and corrosion. These problems not only reduce efficiency but also increase maintenance expenses, posing a significant challenge in liquid concentration processes.

In addition, the power consumption of cooling systems in data centers is a significant component of the overall energy usage in such facilities. This consumption varies based on several factors, including the size of the data center, its location, the efficiency of the cooling system, and the ambient climate conditions.

Moreover, hydrogen generally cannot be found naturally in its pure form and must therefore be manufactured. The method used to produce hydrogen determines whether it is a clean and sustainable fuel. The energy content of hydrogen is typically measured by weight in kilograms, with 1 kg of hydrogen-containing approximately the same amount of energy as 2.6 kg of natural gas. This means that 1 kg of hydrogen has a heating value of 33 kWh, while petrol and diesel hold about 12 kWh per kg. Although hydrogen has the highest energy content of any common fuel by weight, it has the lowest energy content by volume when in liquid form (about four times less than gasoline). Additionally, it takes more energy to produce hydrogen (by separating it from other elements in molecules) than hydrogen provides when it is converted to useful energy.

Water electrolysis is an electrochemical process that produces hydrogen using only water and electricity, making it an emission-free technology. The four types of water electrolysis technologies are Alkaline, AEM, PEM, and solid oxide water electrolysis, based on their electrolyte, operating conditions, and ionic agents. Alkaline and PEM technologies are mature and available in the market, while AEM and Solid Oxide are still in the R&D phase.

### SUMMARY OF THE DISCLOSURE

According to one aspect of the present disclosure, a multi-effect evaporation system can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a heat source to at least one of the one or more falling film evaporators. The multi-effect evaporation system can also include a condenser configured to receive vapor from the one or more falling film evaporators and the heat source can include an outlet from an electrolyzer.

In some embodiments, the plurality of thermoplastic tubes is fabricated from heat-conductive polyphenylene sulfide, polypropylene, or a combination thereof. In some embodiments, the one or more falling film evaporators are arranged in series and progressively concentrate feedwater and utilize produced vapor from another evaporator or a separate heat source system as its heat source. In some embodiments, the system can include a heat exchanger residing between the electrolyzer and the one or more falling film evaporators. In some embodiments, the system can include a flash chamber residing between the electrolyzer and the one or more falling film evaporators. In some embodiments, an outlet coolant from the electrolyzer is fed to the flash chamber and flashed vapor from the flash chamber is fed to the one or more falling film evaporators. In some embodiments, a condensed steam outlet from the one or more falling film evaporators is mixed with an outlet liquid stream from the flash chamber.

In some embodiments, the shell is reinforced with at least one of fibers or filers. In some embodiments, the one or more falling film evaporators comprise a plurality of falling film evaporators and are arranged in parallel. In some embodiments, the condenser can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a refrigerant or coolant to the tube bundle that flows through the plurality of thermoplastic tubes.

According to another aspect of the present disclosure, a method for operating a multi-effect evaporation system can include feeding feedwater to one or more falling film evaporators. Each evaporator can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a heat source to at least one of the falling film evaporators. The method can also include feeding the heat source to the one or more falling film evaporators, wherein the heat source comprises an outlet from a fuel cell; feeding vapor from the one or more falling film evaporators to the one or more falling film evaporators and a condenser; and condensing the vapor to generate an outlet distilled vapor.

In some embodiments, the plurality of thermoplastic tubes is fabricated from heat-conductive polyphenylene sulfide, polypropylene, or a combination thereof. In some embodiments, the one or more falling film evaporators are arranged in series and progressively concentrate the feedwater and utilize produced vapor from another evaporator or a separate heat source system as its heat source. In some embodiments, the method can include, prior to feeding the heat source to the one or more falling film evaporators, feeding the heat source to a heat exchanger residing between the fuel cell and the one or more falling film evaporators. In some embodiments, the method can include, prior to feeding the heat source to the one or more falling film evaporators, feeding the heat source to a flash chamber residing between the fuel cell and the one or more falling film evaporators. In some embodiments, the method can include feeding an outlet coolant from the fuel cell to the flash chamber; and feeding flashed vapor from the flash chamber to the one or more falling film evaporators. In some embodiments, a condensed steam outlet from the one or more falling film evaporators is mixed with an outlet liquid stream from the flash chamber.

In some embodiments, the shell is reinforced with at least one of fibers or filers. In some embodiments, the one or more falling film evaporators comprise a plurality of falling film evaporators and are arranged in parallel. In some embodiments, the condenser can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a refrigerant to the tube bundle that flows through the plurality of thermoplastic tubes.

According to another aspect of the present disclosure, a multi-effect evaporation system can include one or more falling film evaporators. Each evaporator can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a heat source to at least one of the falling film evaporators. The system can also include a condenser configured to receive vapor from the one or more falling film evaporators, and the heat source can include an outlet from a data center rack.

In some embodiments, the plurality of thermoplastic tubes is fabricated from heat-conductive polyphenylene sulfide, polypropylene, or a combination thereof. In some embodiments, the one or more falling film evaporators are arranged in series and progressively concentrate feedwater and utilize produced vapor from another evaporator or a separate heat source system as its heat source. In some embodiments, the system can include a heat exchanger residing between the data center and the one or more falling film evaporators. In some embodiments, the system can include a flash chamber residing between the data center and the one or more falling film evaporators. In some embodiments, an outlet coolant from the data center is fed to the flash chamber and flashed vapor from the flash chamber is fed to the one or more falling film evaporators. In some embodiments, a condensed steam outlet from the one or more falling film evaporators is mixed with an outlet liquid stream from the flash chamber.

In some embodiments, the shell is reinforced with at least one of fibers or filers. In some embodiments, the one or more falling film evaporators comprise a plurality of falling film evaporators and are arranged in parallel. In some embodiments, the condenser can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a refrigerant or a coolant to the tube bundle that flows through the plurality of thermoplastic tubes.

According to another aspect of the present disclosure, a method for operating a multi-effect evaporation system can include feeding feedwater to one or more falling film evaporators. Each evaporator can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a heat source to at least one of the falling film evaporators. The method can also include feeding the heat source to the one or more falling film evaporators, wherein the heat source comprises an outlet from an industrial waste heat stream; feeding vapor from the one or more falling film evaporators to the one or more falling film evaporators and a condenser; and condensing the vapor to generate an outlet distilled vapor.

In some embodiments, the plurality of thermoplastic tubes is fabricated from heat-conductive polyphenylene sulfide, polypropylene, or a combination thereof. In some embodiments, the one or more falling film evaporators are arranged in series and progressively concentrate the feedwater and utilize produced vapor from another evaporator or a separate heat source system as its heat source. In some embodiments, the method can include, prior to feeding the heat source to the one or more falling film evaporators, feeding the heat source to a heat exchanger residing between the industrial waste heat stream and the one or more falling film evaporators. In some embodiments, the method can include, prior to feeding the heat source to the one or more falling film evaporators, feeding the heat source to a flash chamber residing between the industrial waste heat stream and the one or more falling film evaporators. In some embodiments, the method can include feeding an outlet coolant from the industrial waste heat stream to the flash chamber; and feeding flashed vapor from the flash chamber to the one or more falling film evaporators. In some embodiments, a condensed steam outlet from the one or more falling film evaporators is mixed with an outlet liquid stream from the flash chamber.

In some embodiments, the shell is reinforced with at least one of fibers or filers. In some embodiments, the one or more falling film evaporators comprise a plurality of falling film evaporators and are arranged in parallel. In some embodiments, the condenser can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheets; and an inlet configured to feed a refrigerant or a coolant to the tube bundle that flows through the plurality of thermoplastic tubes.

According to another aspect of the present disclosure, a falling film evaporator can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheet via the respective grommets; and an inlet configured to feed a heat source to the tube bundle that flows through the plurality of thermoplastic tubes.

In some embodiments, the grommets of the first and second plurality of holes are comprised of Ethylene-propylene diene monomer or Fluoroelastomers. In some embodiments, each grommet has a thickness of at least 0.5 mm smaller than an outlet diameter of each of the thermoplastic tubes. In some embodiments, the plurality of thermoplastic tubes is fabricated from heat-conductive polyphenylene sulfide, polypropylene, or a combination thereof. In some embodiments, the shell is reinforced with at least one of fibers or filers. In some embodiments, the shell comprises one or more exterior insulation layers. In some embodiments, the heat source comprises a liquid. In some embodiments, the evaporator can include an outlet configured to feed the liquid heat source away from the evaporator. In some embodiments, the heat source comprises steam. In some embodiments, the steam exits the plurality of thermoplastic tubes as a condensate.

According to another aspect of the present disclosure, a shell and tube condenser can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheet via the respective grommets; and an inlet configured to feed a refrigerant to the tube bundle that flows through the plurality of thermoplastic tubes.

In some embodiments, the grommets of the first and second plurality of holes are comprised of Ethylene-propylene diene monomer or Fluoroelastomers. In some embodiments, each grommet has a thickness of at least 0.5 mm smaller than an outlet diameter of each of the thermoplastic tubes. In some embodiments, the plurality of thermoplastic tubes is fabricated from heat-conductive polyphenylene sulfide, polypropylene, or a combination thereof. In some embodiments, the shell is reinforced with at least one of fibers or filers. In some embodiments, the shell comprises one or more exterior insulation layers.

According to another aspect of the present disclosure, a falling film evaporator can include a shell comprised of a polymer composite material; a first plate sheet connected to a first end of the shell comprising a first plurality of holes, each of the first plurality of holes comprising a grommet; a second plate sheet connected to a second end of the shell comprising a second plurality of holes, each of the second plurality of holes comprising a grommet; a tube bundle residing within the shell and comprising a plurality of thermoplastic tubes, each thermoplastic tube being connected to the first and second plate sheet via the respective grommets; and an inlet configured to feed feedwater to the tube bundle that flows through the plurality of thermoplastic tubes.

In some embodiments, the grommets of the first and second plurality of holes are comprised of Ethylene-propylene diene monomer or Fluoroelastomers. In some embodiments, each grommet has a thickness of at least 0.5 mm smaller than an outlet diameter of each of the thermoplastic tubes. In some embodiments, the plurality of thermoplastic tubes is fabricated from heat-conductive polyphenylene sulfide, polypropylene, or a combination thereof.

### BRIEF DESCRIPTION OF THE FIGURES

FIGS. 1A-1D show various views of a shell and tube condenser according to some embodiments of the present disclosure.

FIGS. 2A-2D show various views of a falling film evaporator with a hot liquid heat source according to some embodiments of the present disclosure.

FIGS. 3A-3E show various views of a falling film evaporator with a steam heat source according to some embodiments of the present disclosure.

FIGS. 4A-4C show various views of a grommet for use within the disclosed heat exchangers according to some embodiments of the present disclosure.

FIGS. 5A-5C show various internal views of the disclosed heat exchangers according to some embodiments of the present disclosure.

FIG. 6 shows an example steam-driven multi-effect evaporation system with horizontal falling film evaporators according to some embodiments of the present disclosure.

FIG. 7 shows an example parallel feed hot liquid driven multi-effect evaporation system with horizontal falling film evaporators according to some embodiments of the present disclosure.

FIG. 8 shows an example steam-driven multi-effect evaporation system with vertical falling film evaporators according to some embodiments of the present disclosure.

FIG. 9 shows an example thermal vapor compression (TVC) multi-effect evaporation system with horizontal falling film evaporators according to some embodiments of the present disclosure.

FIG. 10 shows an example mechanical vapor compression (MVC) multi-effect evaporation system with horizontal falling film evaporators according to some embodiments of the present disclosure.

FIGS. 11A-D are plots showing various cross-sections of thermoplastic tubes according to some embodiments of the present disclosure.

FIG. 12 is a schematic representation of a multi-effect evaporation system according to some embodiments of the present disclosure.

FIG. 13A is a schematic representation of a falling film evaporator driven by hot liquid as the heat source according to some embodiments of the present disclosure. FIG. 13B is a schematic representation of a falling film evaporator driven by steam or vapor as the heat source according to some embodiments of the present disclosure. FIG. 13C is a schematic representation of a condenser according to some embodiments of the present disclosure.

FIG. 14 is a flow diagram illustrating the process of heat utilization from a data center coupled with a liquid-driven multi-effect evaporation system according to some embodiments of the present disclosure.

FIG. 15 is another flow diagram illustrating the process of heat utilization from a data center coupled with a liquid-driven multi-effect evaporation system according to some embodiments of the present disclosure.

FIG. 16 is another flow diagram illustrating the process of heat utilization from a data center coupled with a steam-driven multi-effect evaporation system according to some embodiments of the present disclosure.

FIG. 17 is a flowchart showing an example process for utilizing waste heat for water treatment according to some embodiments of the present disclosure.

FIG. 18 is a schematic representation of a system for utilizing waste heat from an electrolyzer for water treatment according to some embodiments of the present disclosure.

FIG. 19 is schematic of an example plant according to some embodiments of the present disclosure.

The drawings are not necessarily to scale, or inclusive of all elements of a system, emphasis instead generally being placed upon illustrating the concepts, structures, and techniques sought to be protected herein.

### DESCRIPTION

The following description sets forth exemplary aspects of the present disclosure. It should be recognized, however, that such a description is not intended as a limitation on the scope of the present disclosure. Rather, the description also encompasses combinations and modifications to those exemplary aspects described herein.

Falling film evaporation generally encompasses two primary heat transfer mechanisms. Firstly, thin film evaporation operates through conduction and/or convection across the film, where phase change occurs at the interface. The efficiency of this process depends on factors such as film thickness and whether the flow is laminar or turbulent. If the heat flux surpasses the threshold for nucleation onset, nucleate boiling occurs, leading to the formation of bubbles within the thin film, either at the heated wall or within enhanced structured surface channels, which then migrate towards the interface. Gravity typically facilitates the downward flow of the film, resembling falling film condensation in many aspects. This evaporation process can occur with a laminar film flowing down the exterior of a horizontal tube or the interior side of a vertical tube, analogous to Nusselt's (1916) theory for laminar film condensation, with film thickness largely dictating heat transfer. Local film Reynolds numbers can determine whether the film develops surface waves or transitions to turbulence. Conversely, falling evaporating films exhibit nucleate boiling, further enhancing heat transfer coefficients. Dry patches may also form on the tube surface during evaporation, greatly impeding heat transfer, as heat exchange is then limited to the vapor phase in those areas.

In falling film evaporators, heat transfer occurs through the exchange of latent heat. This is different from the sensible heat transfer that takes place in liquid-liquid heat exchangers and heat recovery steam generators (HRSGs). Latent heat is the energy that is absorbed or released by a fluid when it undergoes a change in phase, such as from liquid to vapor or vice versa. The amount of latent heat exchanged depends on the temperature and pressure of the fluid. On the other hand, sensible heat transfer occurs when the temperature of a fluid changes without a change in its phase, which is the case in liquid-liquid heat exchangers and heat recovery steam generators (HRSGs).

In evaporators like falling film evaporators, there is a significant exchange of energy through latent heat. For example, when water is subjected to sensible heat transfer, a drop of 1° C. in temperature releases around 4.18 kJ of energy per kg of water. But during a phase change, such as from liquid to vapor or vice versa, water releases or absorbs around 2500 kJ of energy per kg. Therefore, evaporators and condensers exchange a much larger amount of energy through latent heat compared to liquid-liquid heat exchangers and HRSGs, where sensible heat transfer is the primary mode of heat transfer.

Embodiments of the present disclosure relate to an improved falling film evaporation system and an improved shell and tube condenser, each utilizing improved materials and employing various design features that enable use of such materials. A falling film evaporator is a specific type of shell and tube heat exchanger that is generally used to evaporate a portion of a fluid. A shell and tube condenser operates in a similar manner but with a different heat transfer goal; the condenser utilizes a coolant (it can be a refrigerant or a cold stream) to cool some other vapor and change its phase to liquid. The disclosed falling film evaporation system and the condenser system can, instead of metal, utilize thermoplastic tubes and diverse polymer composite shells. Such a lightweight thermoplastic material allows for the construction of the evaporator and condenser bodies using a variety of polymer composites instead of carbon steel or other metal-based materials.

The disclosed design offers significant benefits and advantages that spawn across a wide variety of diverse industrial applications. For example, there is a significant decrease in capital expenditure due to the lower cost of thermoplastic tubes, PVC pipes, and glass-reinforced polymers (GRP) components. This is a major advantage compared to conventional materials such as titanium, Al-brass tubes, carbon steel, and stainless-steel tubes, vessels, and pipes. Second, because these thermoplastic and polymer materials and such materials are significantly more corrosion-resistant and have anti-scaling properties, use of the disclosed system can reduce the need for anti-corrosive chemicals resulting in lower operational expenditure, which can ensure increased longevity of the system and make the disclosed process more environmentally friendly. Moreover, these materials have a low degradation in performance compared to metals, which can ensure a more consistent thermal performance of the processes over time. Next, these materials are quicker and easier to handle during construction and assembly, reducing time and effort expenditures during the assembly and installation process. Additionally, the materials are significantly lighter than metal-based materials, which can reduce the cost of transportation and necessary supporting infrastructure. Finally, the aforementioned corrosion resistance and anti-scaling properties enable the system to be used with hypersaline waters and other highly corrosive industrial wastewater. Table 1 lists the test results of different mediums that the tube material can handle without any impact.

TABLE 1

| | | Testing time |
|---|---|---|
| | Testing | without observing |
| Medium | Temperature | any influence (hr) |
| HCL (Hydrochloric Acid) 36% | 100° C. | 720 |
| H2SO4 (Sulfuric Acid) 60% | 120° C. and | 4320 |
| | 140° C. | |
| H2SO4 (Sulfuric Acid) 70% | 150° C. | 336 |
| HF (Hydrofluoric Acid) 40% | 100° C. | 336 |
| NaOH (Caustic Soda) 72% | 23° C. | 1656 |
| H3PO4 (Phosphoric Acid) 85% | 158° C. | 4320 |
| Seawater 65000 ppm | 80° C. | 4320 |

As discussed above, shell and tube heat exchangers are generally completely made of metal, but simply replacing the metal-based tubes that perform the heat transfer within the system with thermoplastic tubes comes with various complications. For example, because both the plate sheet and the tubes are generally metal, connecting them in a sealed manner is straightforward via welding or expansion joint or both. However, thermoplastic materials cannot be welded or connected through expansion joints to metal plate sheets, meaning the plate sheets would need to be made of a composite polymer. But connecting thermoplastics and polymers cannot be accomplished via welding or expansion joints technique, and therefore the disclosed system utilizes various grommets or O-rings to facilitate a sealed connection between the components.

In addition, because metal is such a strong material, there is significant structural support within the system simply by virtue of the material. In other words, the tubes provide structural support to the plate sheets and the plate sheets provide structural support to the tubes. This prevents bending and provides enforcement throughout the system, specifically when the system is under vacuum conditions.

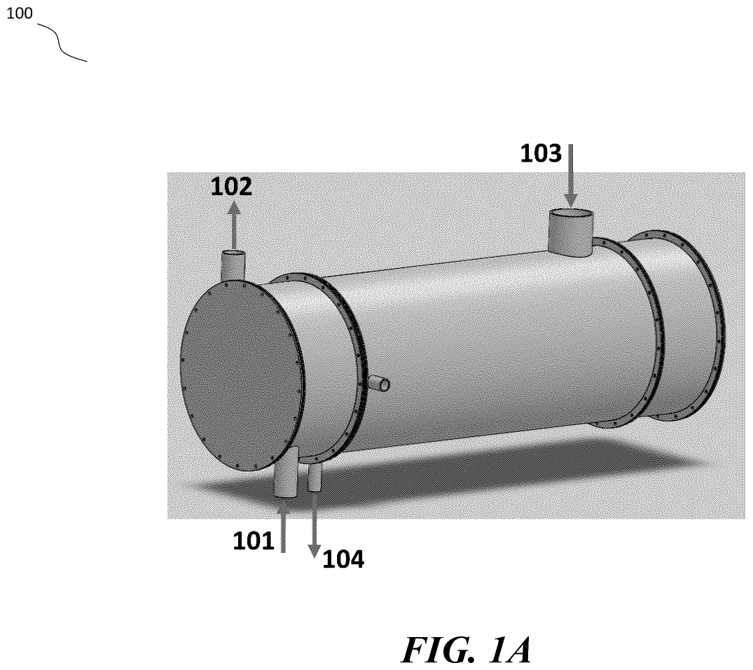

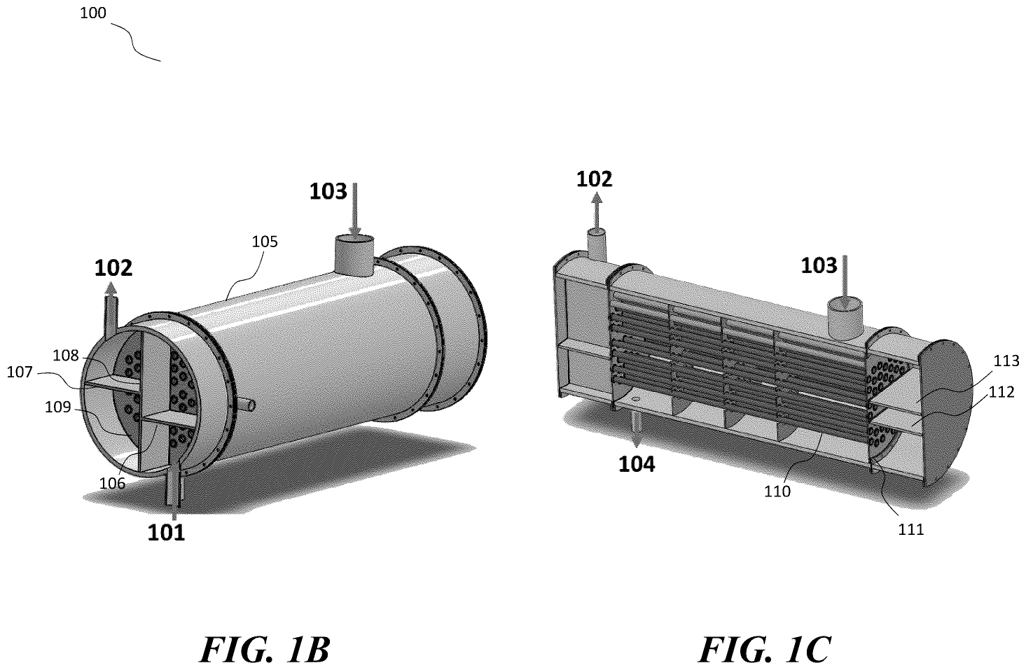

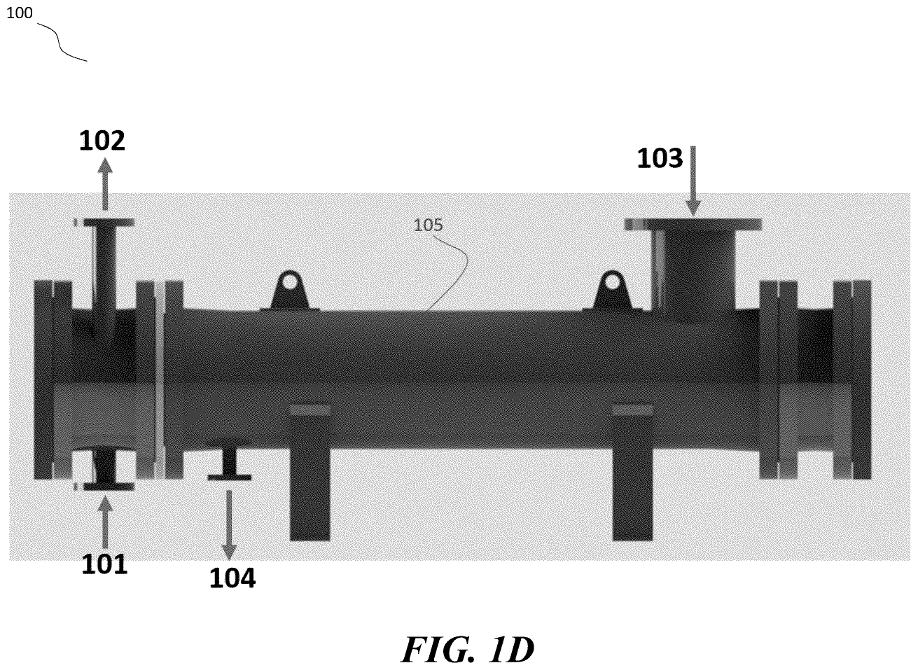

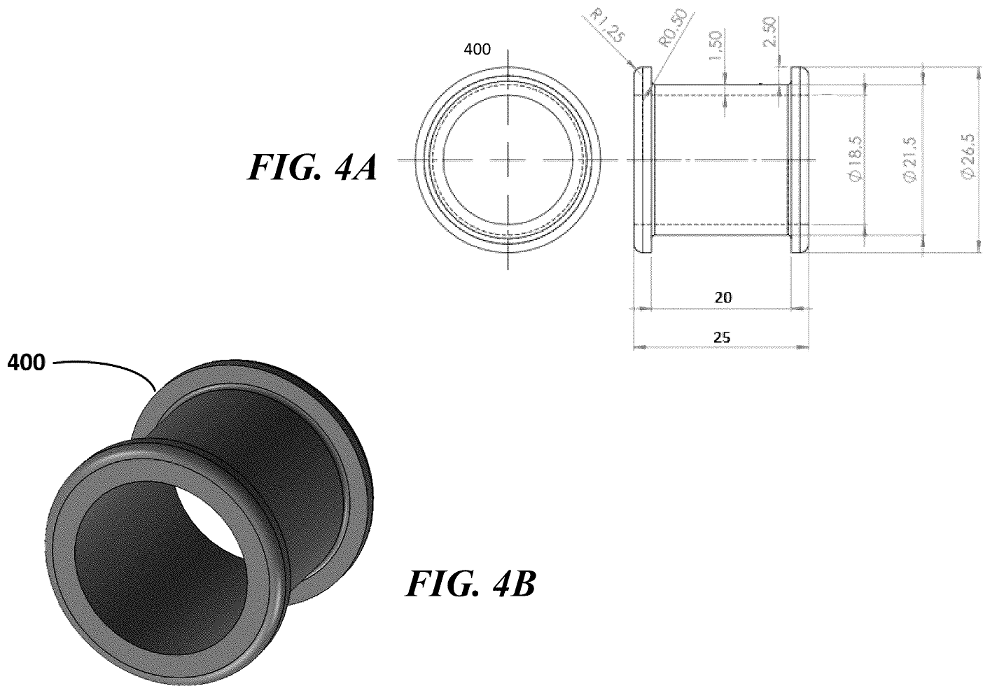

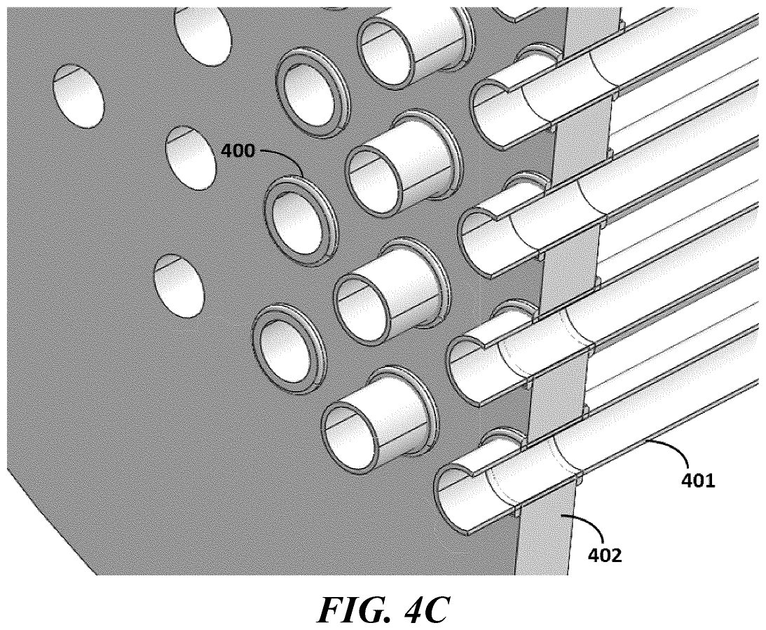

FIGS. 1A-1D show various views of a shell and tube condenser 100 according to some embodiments of the present disclosure. In particular, FIG. 1A is a perspective view of the condenser 100, FIG. 1B is another perspective view of the condenser 100 with an end part removed, and FIG. 1C illustrates the inside of the condenser 100. FIG. 1D illustrates a side view of the condenser 100. In some embodiments, the condenser 100 can include plate sheets 109 and a tube bundle 110 that includes a plurality of tubes. Each tube of the tube bundle 110 can be connected, in a sealed manner, to each plate sheet 109. Moreover, the tube bundle 110 resides within the shell 105. In some embodiments, the tubes of the tube bundle 110 can be connected to the plate sheets 109 and 111 via grommets or O-rings (not shown, additional details discussed in relation to FIGS. 4A-4C). In some embodiments, each of the tubes can be fabricated from heat-conductive polyphenylene sulfide, polypropylene, or a combination thereof.

As shown in FIG. 1B, partitions 106, 107 and 108 can separate the entry holes into the tubes of the tube bundle 110 into separate sections. During the operation of system 100, a coolant (e.g., a refrigerant) flows into the system 100 via an inlet 101. As shown in FIG. 1B, the coolant enters and flows through the tubes of the tube bundle 110 that are separated by the partitions 106, 107 and 108 toward the opposite plate sheet 111 which includes partitions 112 and 113. The coolant then flows back toward plate sheet 109 and exits the system via the outlet 102. In addition, a vapor flows into the shell 105 via the product inlet 103. The vapor can experience cooling due to the coolant flowing through the tube bundle 110, and, after condensation occurs, exits in liquid phase via product outlet 104.

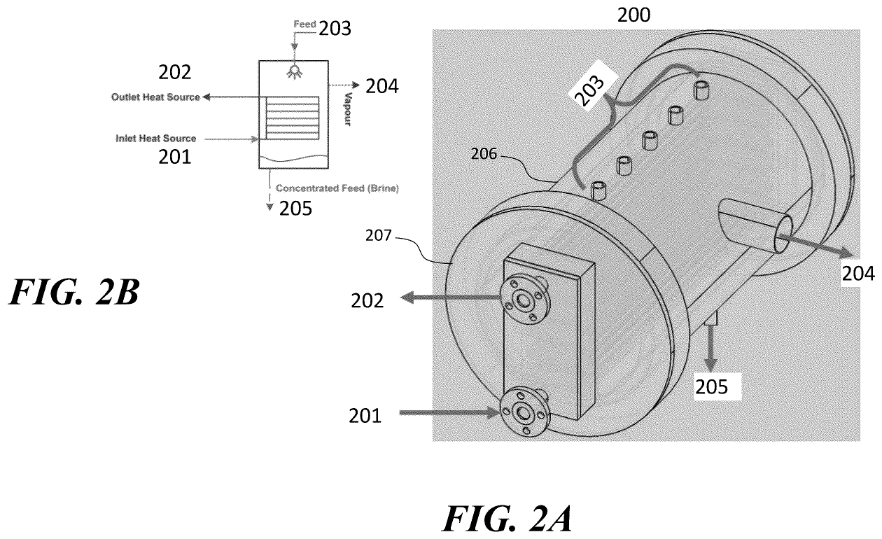

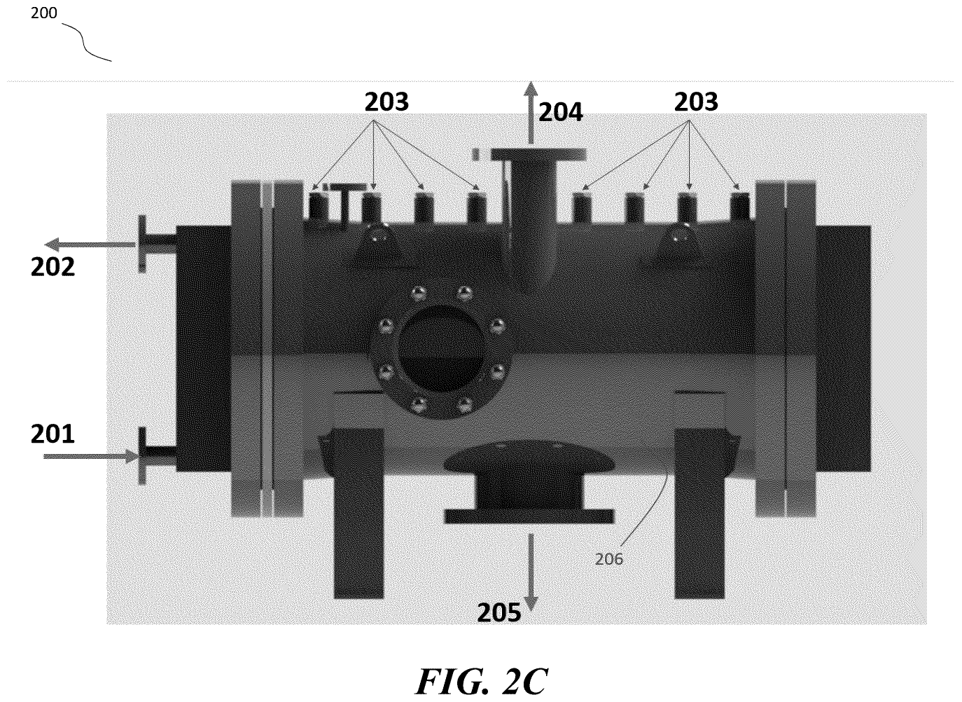

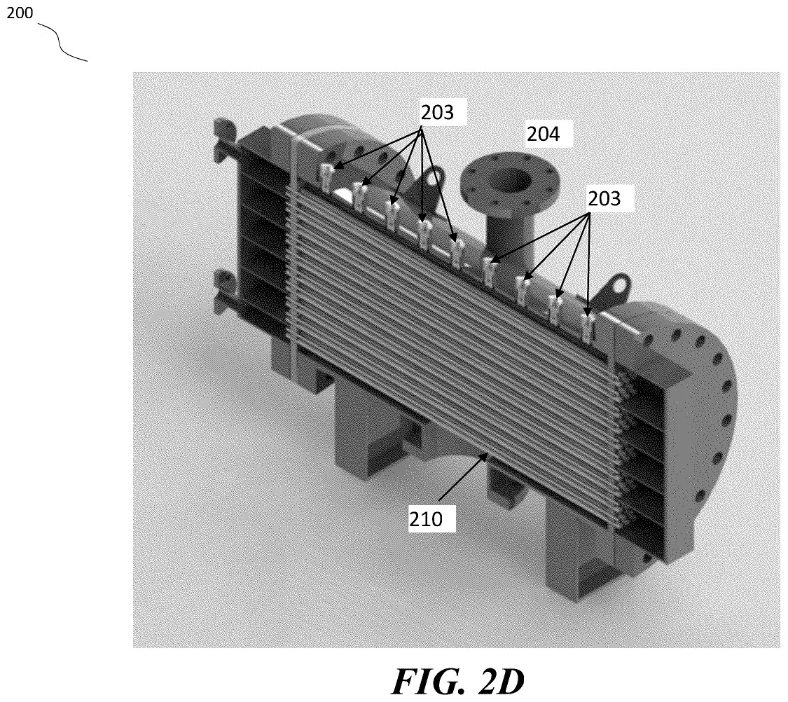

FIGS. 2A-2D show various views of a falling film evaporator 200 with a hot liquid heat source according to some embodiments of the present disclosure. FIG. 2A shows a perspective view of the evaporator 200, which can have a similar internal makeup as the condenser 100 of FIG. 1A-1C. The evaporator 200 can include an inlet 201 that provides the liquid heat source to the system. Although not shown, the evaporator 200 can have a tube bundle and plate sheets contained within the shell 206, similar to the condenser 100. The liquid heat source can flow through the tube bundle from the plate sheet 207 to the opposite plate sheet then flows back toward plate sheet 207 and leave the system via the outlet 202. In addition, the shell 206 can include nozzles 203 (or other inlets) that feed feedwater into the shell 206, contacting the exterior surface of the tube bundle carrying the liquid source with a film of feedwater, causing the feedwater to be heated and evaporated. Vapor can exit the system via the vapor outlet 204, and concentrated feed/brine can exit the system via outlet 205.

In addition, FIG. 2C shows a side view of the evaporator 200 and FIG. 2D shows a perspective view of the evaporator 200 with the inner section exposed. On the interior of the evaporator 200, tube bundles 210 run about the length of the evaporator consistent with the embodiments discussed herein.

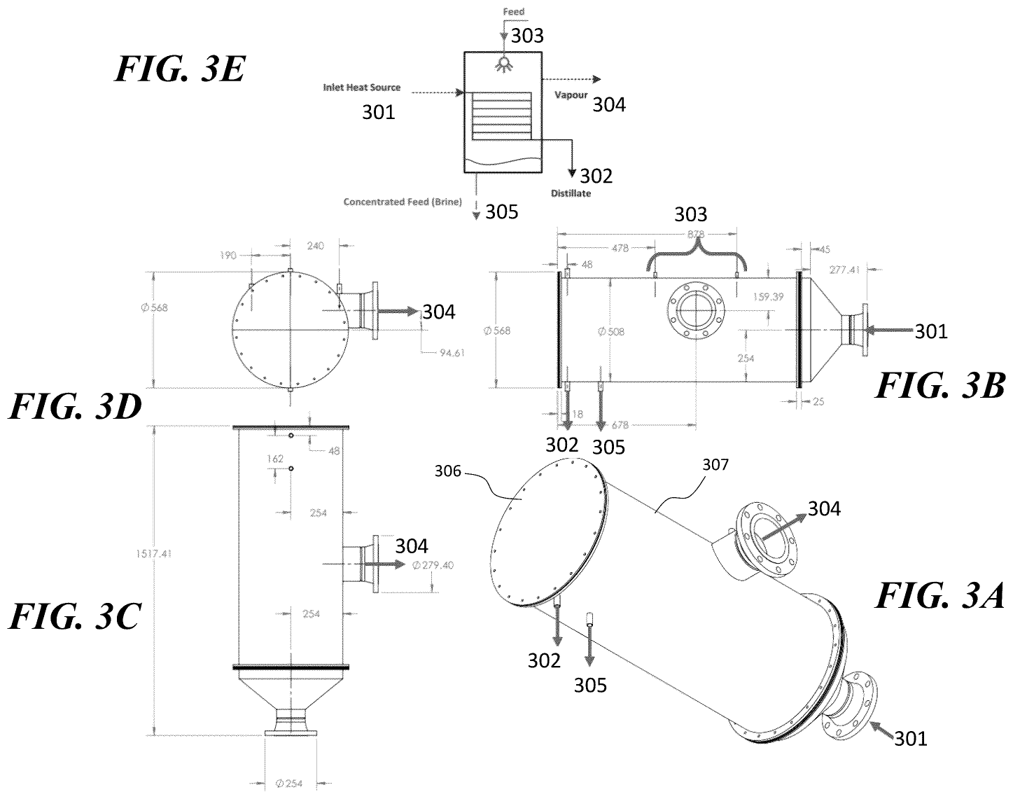

FIGS. 3A-3E show various views of a falling film evaporator 300 with a steam heat source according to some embodiments of the present disclosure. The evaporator 300 can be similar to the evaporator 200 except that the heat source is vapor comes from another evaporator or steam. The evaporator 300 can include an inlet 301 that feeds either steam or other vapor into the shell 307 that comprises a tube bundle within its interior. In addition, the shell 307 comprises various nozzles 303 (or other inlets) that feed feedwater into the shell 307, which is distributed on the outside of the tube bundle. In some embodiments, the number of feedwater nozzles can be dependent on various factors, such as the feedwater flow rate, the number and configuration of tube bundles, and the size and capacity of the shell 307. As the heat source and the feedwater film flow through and interact within the system, the heat source heats up and evaporates the feedwater film. In addition, the shell 307 can include a vapor outlet 304 for vapor to escape the system, as well as a distillate outlet 302 for condensed heat source as distillate to escape the system. Concentrated feed/brine can exit the system via outlet 305.

FIGS. 4A-4C show various views of a grommet 400 for use within the disclosed heat exchangers according to some embodiments of the present disclosure. In some embodiments, the grommet 400 can reside within each hole of the plate sheet 402 and be configured to receive a tube 401 from the various tube bundles described herein such that a sealed connection is created. In some embodiments, the grommet 400 can have a thickness of about 20 mm or more. In order to achieve a secure seal, it is important for the grommet's inlet diameter to be at least 0.5 mm smaller than the tube's outlet diameter. This difference in size can help maintain the necessary pressure between the grommet's internal surface and the tube's external surface.

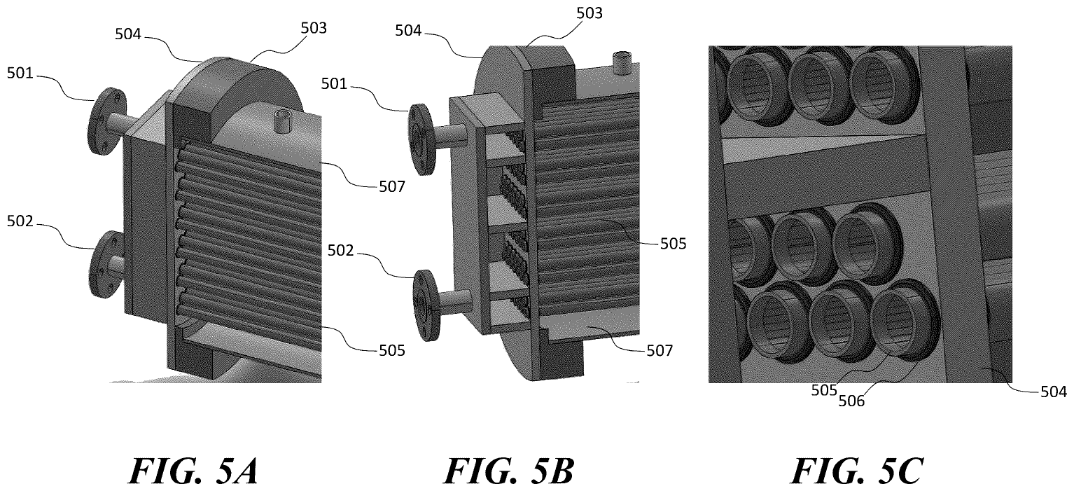

FIGS. 5A-5C show various internal views of the disclosed heat exchangers according to some embodiments of the present disclosure. The heat exchanger shown in FIGS. 5A-5C can be the evaporator 200. In FIG. 5A, the inlet 502 can provide a heating source (e.g., cither a liquid or a steam/vapor heat source) that enters into and travels through the various tubes 505 in a left to right direction and vice versa. The tubes 505 form a bundle and reside within the shell 507. The shell can be connected to a plate sheet 504 through a connector 503 (but not limited to this design), which includes various holes which can receive the tubes 505. Moreover, as shown in FIG. 5C, each hole of the plate sheet 504 comprises a grommet 506 that receives the tube 505 to create a sealed connection. Similar to the systems discussed above, the heat source travels through the tubes 505 in a left-to-right direction and then returns in a right-to-left direction to exit the system via the outlet 501.

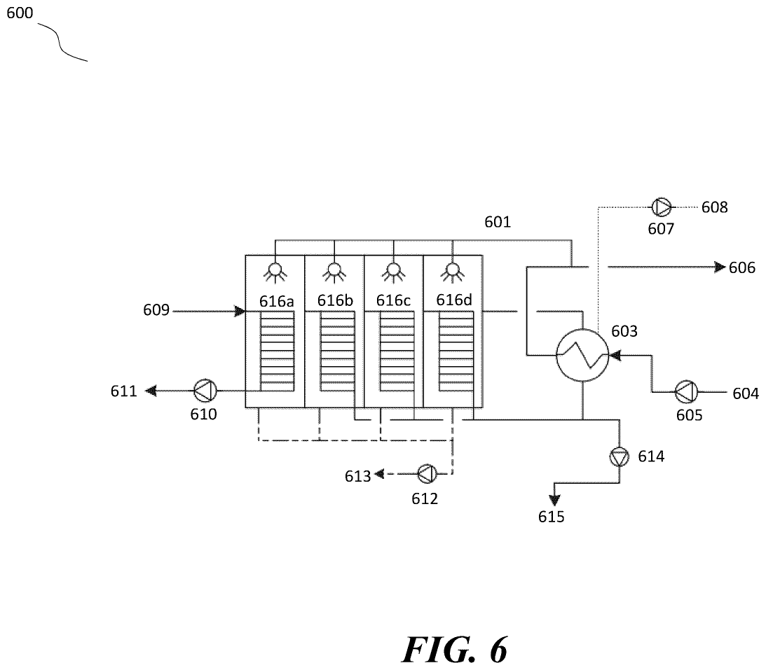

FIG. 6 shows an example steam-driven multi-effect evaporation system 600 with horizontal falling film evaporators 616a-d (but not limited to these number of effects) according to some embodiments of the present disclosure. The system 600 can include various nozzles 601 that introduce feedwater into various horizontal falling film evaporators 616a-d. In some embodiments, each of the falling film evaporators 616 can be similar to or the same as the evaporator 300 described herein. As the feedwater enters the falling film evaporators 616a-d, steam also enters the tubes (not shown) of the evaporators at a tube 609 and exits as condensed steam at 611 via a condensate extraction pump 610. In some embodiments, the feedwater 601 can be supplied via a condenser 603, which can be similar to or the same as the condenser 100 described herein. The condenser 603 can receive intake feedwater at 604 from a feedwater pump 605. In addition, the excess feedwater (in this figure, the coolant stream and the feedwater stream are the same, but our design will not be limited to this configuration) can move from the condenser (603) to the cooling stream outlet (606), and the accumulated non-condensable gases can be purged from the system through a vacuum line (608) via a vacuum pump (607). In some embodiments, some of the output from the falling film evaporators 616a-d can be pumped as brine 613 via a brine blowdown pump 612. Finally, freshwater or distillate can leave the system at 615 via a distillate pump 614.

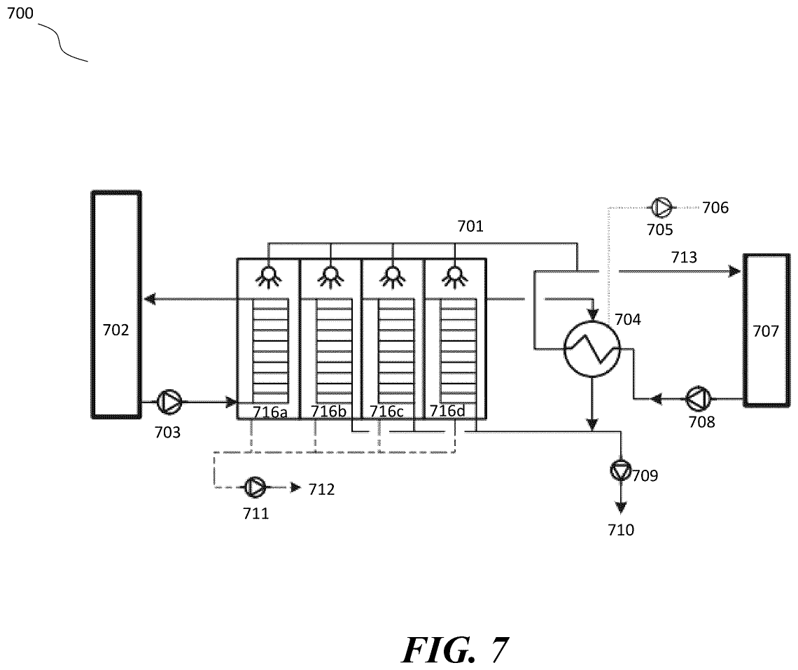

FIG. 7 shows an example of a hot liquid-driven parallel feed multi-effect evaporation system 700 with horizontal falling film evaporators 716a-d (but not limited to these number of effects) according to some embodiments of the present disclosure. The system 700 can include various nozzles 701 that introduce feedwater into various horizontal falling film evaporators 716a-d. In some embodiments the falling film evaporator 716a (the first effect) can be similar to or the same as the evaporator 200 described herein, each of the falling film evaporators 716b-d can be similar to or the same as the evaporator 300 described herein. As the feedwater enters the falling film evaporators 716a-d, a liquid heat source also enters the tubes (not shown) of the evaporator 716a from 702 via a heat source pump 703. In some embodiments, the feedwater 701 can be supplied via a condenser 704, which can be similar to or the same as the condenser 100 described herein. The condenser 704 can receive intake feedwater from 707 via a feedwater pump 708. In addition, the excess feedwater (in this figure, the coolant stream and the feedwater stream are the same, but the disclosed design will not be limited to this configuration) can move from the condenser (704) to the cooling stream outlet (713), and the accumulated non-condensable gases can be purged from the system through a vacuum line (706) via a vacuum pump (705). In some embodiments, some of the output from the falling film evaporators 716a-d can be pumped as brine 712 via a brine blowdown pump 711. Finally, freshwater or distillate can leave the system at 710 via a distillate pump 709.

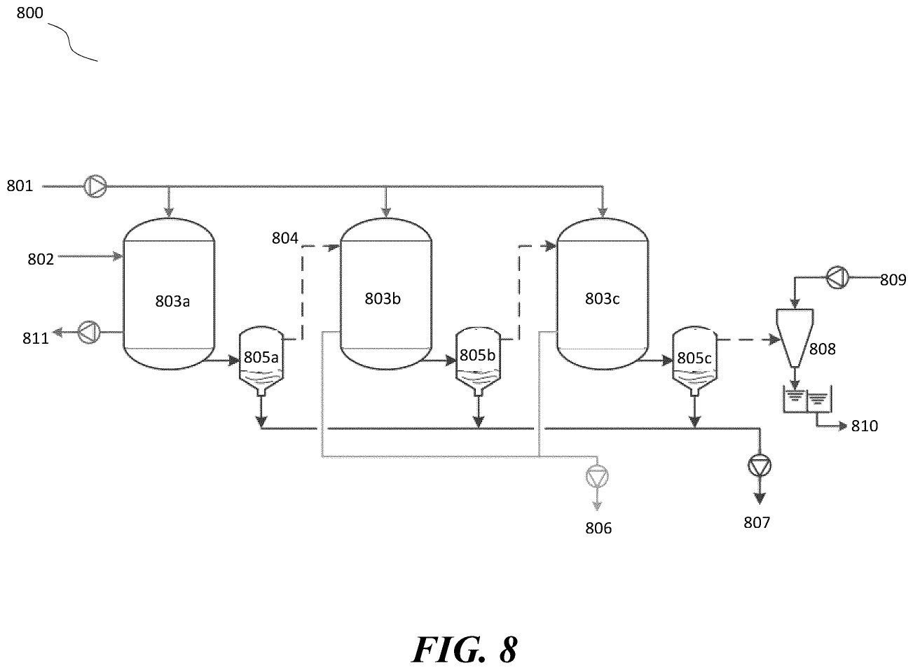

FIG. 8 shows an example steam-driven multi-effect evaporation system 800 with vertical falling film evaporators 803a-c (but not limited to three evaporators) according to some embodiments of the present disclosure. Each of the evaporators 803 can receive feedwater from 801 (stream 801 can come from one or different sources of feedwater). In some embodiments, each of the evaporators 803 can be the same as or similar to the evaporator 300 as described herein but with vertical tube bundle configuration. The evaporator 803a can also receive steam at 802. As it travels through the exterior surface of the tubes (not shown), it heats up and evaporates the feedwater which is distributed inside the tubes (from top to bottom flow) while it has turned to a condensate can exit the system through 811. In some embodiments, the output from the inside of the vertical tube bundles of the evaporator 803a travels as a mixture of liquid/vapor to a separator 805a, which provides vapor as a heat source for evaporator 803b through 804 as it receives feedwater from 801. Moreover, reconcentrated feedwater leaves the separator 805a through 807. The evaporator 803b receives the steam at 804 via the external surface of their tubes to heat the feedwater which flow inside the vertical tubes. As the steam travels through the outside of the tubes (not shown), the feedwater is heated inside the tubes and some of the steam which has turned to a condensate can exit the system as a process condensate at 806. In some embodiments, the output from the evaporator 803b travels as liquid/vapor mixture to a separator 805b, which is fed as a heat source to evaporator 803c as it receives feedwater from 801. Moreover, reconcentrated feedwater leaves the separator 805b as a concentrated feed 807. The evaporator 803c receives the vapor via its tubes to heat the feedwater which is distributed inside the vertical tubes. As the vapor travels through the external surface of the tubes (not shown), the feedwater is heated and some of the vapor which has turned to a condensate can exit the system as a process condensate at 806. In some embodiments, the output from the evaporator 803c travels as liquid/vapor mixture to a separator 805c, which is fed to a barometric condenser 808. Moreover, reconcentrated feedwater leaves the separator 805c as a concentrated feed 807. In some embodiments, the barometric condenser 808 can receive a cooling water supply from 809 and provide a cooling water return at 810. In some embodiments, a condenser such as 100 can be used instead of a barometric condenser 808.

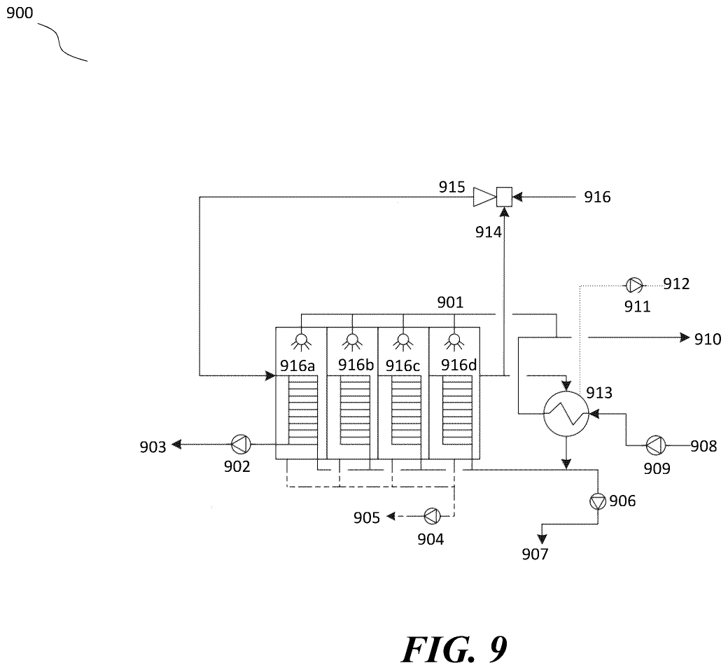

FIG. 9 shows an example thermal vapor compression (TVC) multi-effect evaporation system 900 with horizontal falling film evaporators 916a-d (but not limited to four effects) according to some embodiments of the present disclosure. The system 900 can include various nozzles 901 that introduce feedwater into various horizontal falling film evaporators 916a-d. In some embodiments, each of the falling film evaporators 916 can be similar to or the same as the evaporator 300 described herein. As the feedwater enters the falling film evaporators 916a-d, a steam/vapor heat source also enters the tubes (not shown) of the evaporators from a thermo-compressor 915 and eventually exits as a condensed motive steam 903 via a condensate extraction pump 902. In some embodiments, the thermo-compressor 915 can also provide suction 914 to the output of the evaporators 916a-d and receive motive steam at 916. In some embodiments, the feedwater 901 can be supplied via a condenser 913, which can be similar to or the same as the condenser 100 described herein. The condenser 913 can receive intake feedwater from 908 via a feedwater pump 909. In addition, the excess feedwater (in this figure, the coolant stream and the feedwater stream are the same, but our design will not be limited to this configuration) can move from the condenser (913) to the cooling stream outlet (910), and the accumulated non-condensable gases can be purged from the system through a vacuum line (912) via a vacuum pump (911). In some embodiments, some of the output from the falling film evaporators 916a-d can be pumped as brine 905 via a brine blowdown pump 904. Finally, freshwater or distillate can leave the system at 907 via a distillate pump 906.

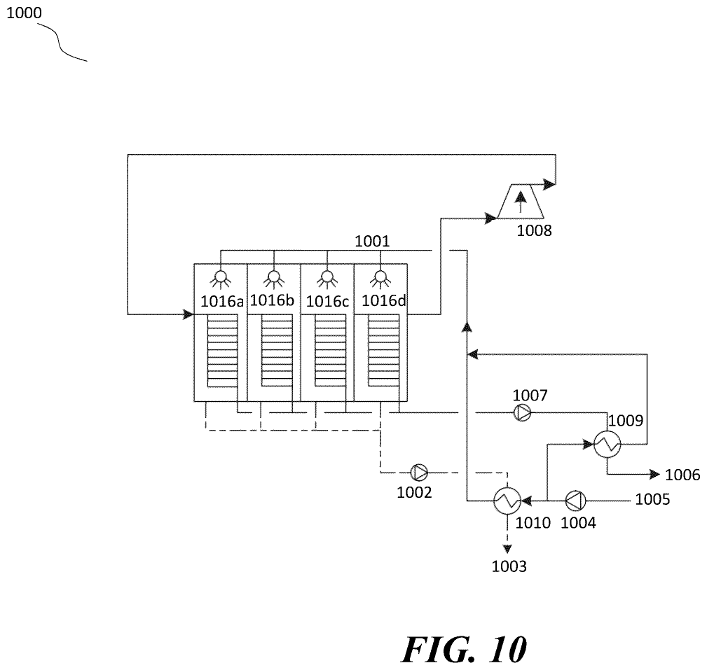

FIG. 10 shows an example mechanical vapor compression (MVC) multi-effect evaporation system 1000 with horizontal falling film evaporators 1016a-d according to some embodiments of the present disclosure. The system 1000 can include various nozzles 1001 that introduce feedwater into various horizontal falling film evaporators 1016a-d. In some embodiments, each of the falling film evaporators 1016 can be similar to or the same as the evaporator 300 described herein. As the feedwater enters the falling film evaporators 1016a-d, a steam/vapor heat source also enters the tubes (not shown) of the evaporators from a mechanical compressor 1008. In some embodiments, the mechanical compressor 1008 can receive its required steam from the evaporators 1016a-d. In some embodiments, the feedwater 1001 can be supplied via 1005 through preheaters 1009 and 1010, which can be a conventional liquid-liquid heat exchanger. The preheaters 1009 and 1010 can receive intake feedwater from 1005 via a feedwater pump 1004. In some embodiments, some of the output from the falling film evaporators 1016a-d can be pumped as brine 1003 via a brine blowdown pump 1002. Finally, freshwater or distillate can leave the system at 1006 via a distillate pump 1007. Outlet brines and freshwater can preheat the feedwater through preheaters 1009 and 1010.

Table. 2 shows anti-scaling properties of various materials. As can be seen in this table, the thermoplastic material (PP-GR75) has approximately up to 98% less scaling than other commonly used materials such as Al-brass, Cu—Ni, stainless-steel, and Al—Mg.

TABLE 2
Measurement of scaling of Calcium
and Magnesium on tube surface

| | Scaling (g/m²) on different tube materials | | | | |
|---|---|---|---|---|---|
| Deposition | | | | Stainless | |
| Type | PP-GR75 | Al-Brass | Cu-Ni 90/10 | Steel | Al-Mg |
| Calcium | 0.21 | 13.38 | 13.45 | 13.00 | 8.00 |
| Magnesium | 0.02 | 0.18 | 0.19 | 0.19 | 1.25 |

Table 3 shows heat transfer properties of various materials. As can be seen, the thermoplastic material has a comparable overall heat transfer coefficient with the lowest degradation over time to other commonly used tube materials such as Al-brass, Alu-Alloy 5052, stainless-steel grade 1.4565, and Titanium GR2.

TABLE 3
Heat transfer coefficient degradation over the time

| | | Tube Material | | | | |
|---|---|---|---|---|---|---|
| | | | Al Brass | Alu Alloy | Titanium | Stainless Steel |
| | | PP-GR75 | 2.0460 | 5052 | GR2 | 1.4565 |
| | | (1.25 mm) | (1 mm) | (1.2 mm) | (0.5 mm) | (0.5 mm) |
| Overall heat | After | 2.532 | 2.957 | 3.002 | 2.883 | 2.784 |
| Transfer | 3000 min | | | | | |
| Coefficient | After | 2.410 | 2.163 | 2.159 | 2.097 | 2.044 |
| (kW/m²K) | 60,000 min | | | | | |

| | | | | | |
|---|---|---|---|---|---|
| Degrade over | 4.8 | 26.8 | 28.1 | 27.2 | 26.6 |
| the time (%) | | | | | |

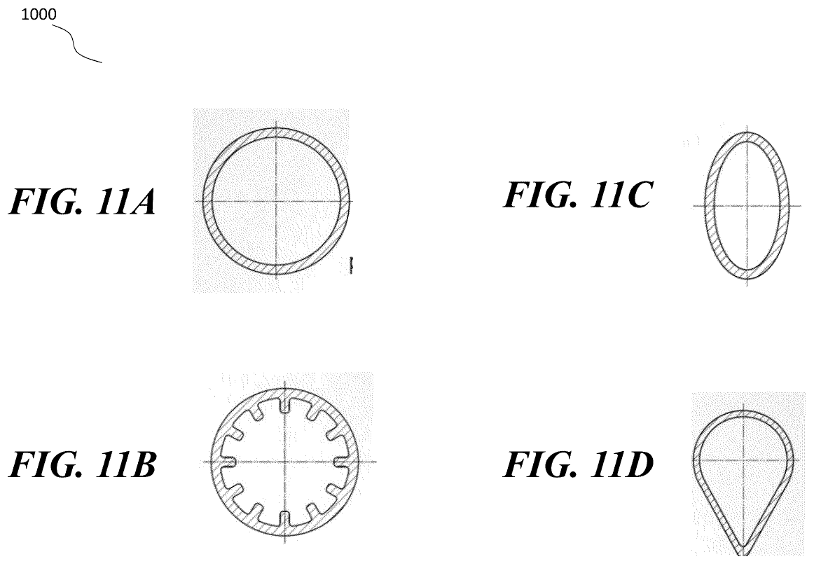

FIGS. 11A-D are plots showing various cross-sections of thermoplastic tubes according to some embodiments of the present disclosure. The disclosed cross-sections can be used for any of the tubes within tube bundles as described herein.

In some embodiments, the disclosed systems and methods can utilize various processes such as Flash Boosted MED and Boosted MED as described in U.S. Pat. Nos. 10,457,568 and 9,365,438, respectively. Moreover, the disclosed principles can utilize one or more of either vertical or horizontal falling film evaporators in any of the above systems, including TVC and MVC systems. Finally, the disclosed principles can be utilized whether the feedwater distribution, freshwater, and brine outlets are configured in a feedforward, backward, parallel, or combination thereof.

The power consumption of cooling systems in data centers is generally evaluated using the Power Usage Effectiveness (PUE) metric, which can reflect the ratio of the total amount of energy used by a data center to the energy used by the IT equipment alone. An example calculation of a PUE is shown below in Equation 1:

$$PUE = \frac{Total Facility Energy}{IT Equipment Energy} = \frac{Cooling Capacity + IT Equipment Energy}{IT Equipment Energy} \qquad ( 1 )$$

In some embodiments, a PUE value of 1.0 means that all the energy consumed by the data center is used by the IT equipment, with no energy spent on cooling or other overhead. For example, in a data center with a PUE of 1.5, if the IT equipment consumes 1 MW of power, the total power consumption of the data center is 1.5 MW. Therefore, the cooling and other overhead consume 0.5 MW.

In practice, most data centers have a PUE greater than 1.0. Typical PUE values can be summarized as follows. First, highly efficient data centers can have PUE values close to 1.1-1.2. In other words, the cooling power consumption of these types of data centers is less than 20% of their IT equipment energy consumption. Second, average data centers can have PUE values of around 1.5-1.8. The cooling capacity of these centers is between 50 to 80% of their IT equipment energy consumption. Finally, less efficient data centers can have PUE values of 2.0 or higher, which means their cooling capacity is more than their IT equipment energy consumption.

Data centers are significant consumers of energy, with a substantial portion dedicated to cooling systems to maintain optimal operating temperatures for IT equipment. Traditional cooling methods are energy-intensive and contribute to high operational costs. Simultaneously, the treatment of wastewater, particularly industrial wastewater and saline water, is a critical environmental and industrial challenge. Many in industry are striving, albeit mostly unsuccessfully, to improve the efficiency of cooling systems to reduce energy consumption. Some of these attempts include 1) free cooling or utilizing outside air or water to cool the data center during favorable weather conditions; 2) liquid cooling or using liquids, which are more efficient at heat transfer than air, to cool IT equipment directly; 3) hot/cold aisle containment or separating hot and cold air streams within the data center to improve cooling efficiency; and 4) renewable energy integration or leveraging renewable energy sources to power cooling systems, reducing the overall carbon footprint.

Embodiments of the present disclosure relate to a multi-effect evaporation system that uses waste heat from data centers to treat various types of wastewater, including industrial, saline, and hypersaline water. The disclosed embodiments can use a series of falling film evaporators that employ thermoplastic tubes and polymer composite plate sheets to produce high-purity freshwater, thereby offering an energy-efficient solution for both data center cooling processes and wastewater treatment systems. The system is designed to provide cooling for data centers while producing boiler-grade freshwater as a by-product by treating a wastewater or saline water stream.

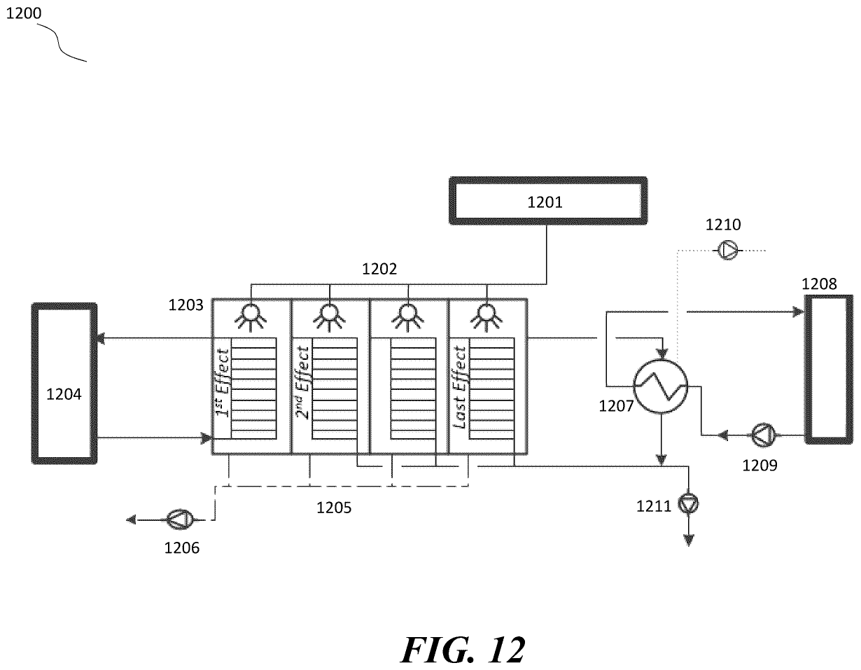

FIG. 12 is a schematic representation of a multi-effect evaporation system 1200 according to some embodiments of the present disclosure. The system 1200 can include a heat source 1204 and four falling film evaporators 1203, although any number of evaporators 1203 could be used depending on specific application requirements and heat source/heat sink temperatures and other design parameters. In some embodiments, fluid from the heat source 1204, (which can be either steam-driven or hot liquid-driven) can pass through the heat exchange surface (not shown) of the first evaporator 1203, which releases energy to the feedwater 1201 that is fed via the nozzles 1202. This energy transfer can cause a portion of the feedwater 1201 to evaporate. In some embodiments, when hot liquid is used as the heat source, the temperature can decrease and the heat source stream cools down. If vapor/steam is used as the heat source, its phase can change during the heat transfer and its latent heat can be released as it condenses.

In some embodiments, the feedwater 1201 can be distributed onto the opposite side of the heat exchange surface within the first evaporator 1203. Then, the resulting vapor can be introduced to the next evaporator 1203 as the heat source, which can condense on the next heat exchange surface and cause a portion of the inlet feedwater 1201 to evaporate on the otherwise of the heat transfer surface of the second evaporator 1203. This can continue with the subsequent evaporators 1203. In other words, the evaporated feedwater 1201 from the second evaporator 1203 can proceed as the heat source for the third evaporator 1203, and this process continues until the last evaporator 1203, with the corresponding vapor produced entering the condenser 1207. In addition, the effluent 1205 (or concentrated feed) from the various evaporators 1203 can exit the system via a brine blowdown pump 1206. Moreover, the condenser 1207 can receive an incoming cooling stream from a heat sink 1208 via a coolant pump 1209 and use this to condense the received vapor from the last evaporator. Then, in some embodiments, feedwater can be collected from the outlet coolant stream of the condenser section (not shown in this figure). Finally, freshwater or distillate exits the system via a freshwater pump 1211. In some embodiments, evaporators 1203 can be the same as or similar to the evaporator 300 as described herein. The first effect of 1203 can be the same as or similar to the evaporator 200 in case of using hot liquid as the heat source.

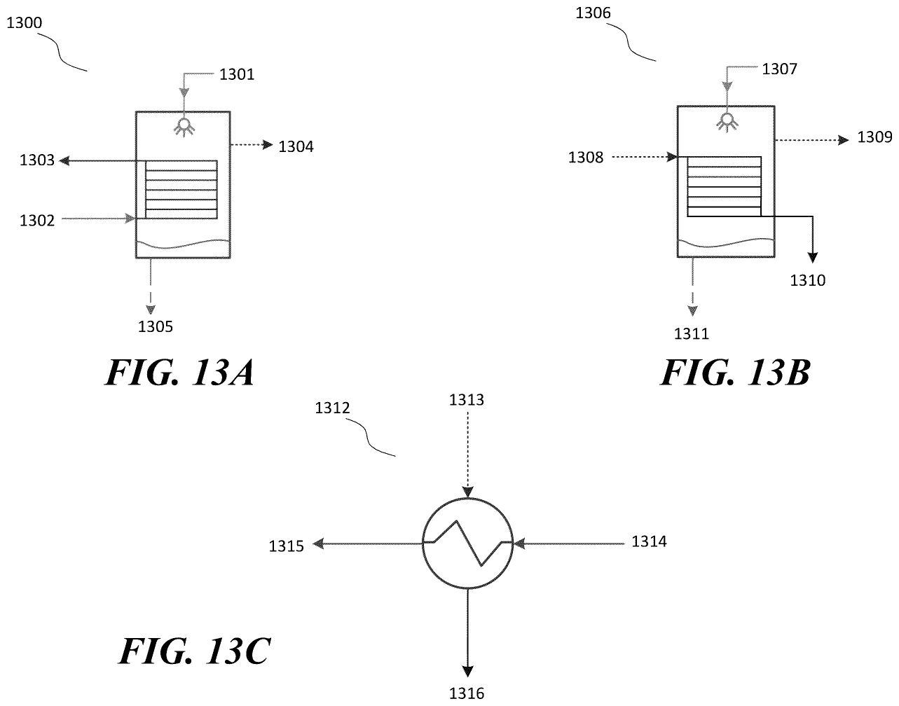

FIG. 13A is a schematic representation of a falling film evaporator driven by hot liquid as the heat source according to some embodiments of the present disclosure. In FIG. 13A, an evaporator 1300 can receive feedwater 1301 and a hot liquid heat source via an inlet 1302. The liquid heat source can interact with and heat up the feedwater 1301 and then exit the evaporator 1300 via the outlet 1303. In addition, this interaction can cause vapor to form, which can exit the evaporator 1300 via 1304. In some embodiments, the evaporator 1300 can be either a horizontal or vertical falling film evaporator. In the case of a horizontal evaporator, the inlet 1302 provides the liquid heat source to the thermoplastic tubes within the evaporator 1300 and the feedwater 1301 travels through the shell via a film mode distribution pattern on the exterior surface of the tube bundle, contacting the thermoplastic tubes. In the case of a vertical evaporator, the inlet 1302 provides the liquid heat source to the shell and the feedwater 1301 travels within the thermoplastic tubes through a falling film pattern. In either scenario, a concentrated feed exits the evaporator at 1305.

FIG. 13B is a schematic representation of a falling film evaporator 1306 driven by steam or vapor as the heat source according to some embodiments of the present disclosure. In FIG. 13B, an evaporator 1306 can receive feedwater 1307 and a hot steam or vapor heat source via an inlet 1308. The steam or vapor heat source can interact with and heat up the feedwater 1307 and then exit the evaporator 1306 via the outlet 1310. In addition, this interaction can cause vapor to form, which can exit the evaporator 1306 as condensed vapor 1310. Moreover, vapor from the feedwater 1307 can also exit the system at 1309. In some embodiments, the evaporator 1306 can be either a horizontal or vertical falling film evaporator. In the case of a horizontal evaporator, the inlet 1308 provides the steam or vapor heat source to the thermoplastic tubes within the evaporator 1306 and the feedwater 1307 is distributed on the tube bundle through the shell side, contacting the thermoplastic tubes. In the case of a vertical evaporator, the inlet 1308 provides the steam or vapor heat source to the shell and the feedwater 1307 travels within the thermoplastic tubes through a falling film pattern. In either scenario, a concentrated feed exits the evaporator at 1311.

FIG. 13C is a schematic representation of a condenser 1312 according to some embodiments of the present disclosure. In FIG. 13C, the condenser 1312 receives vapor in at 1313 (i.e., from an evaporator such as evaporators 200, 300, 1300 and 1306) and a coolant at 1314. The coolant and the vapor interact within the condenser 1312. A coolant stream exits the condenser 1312 at 1315 and condensed vapor exits the condenser 1312 at 1316.

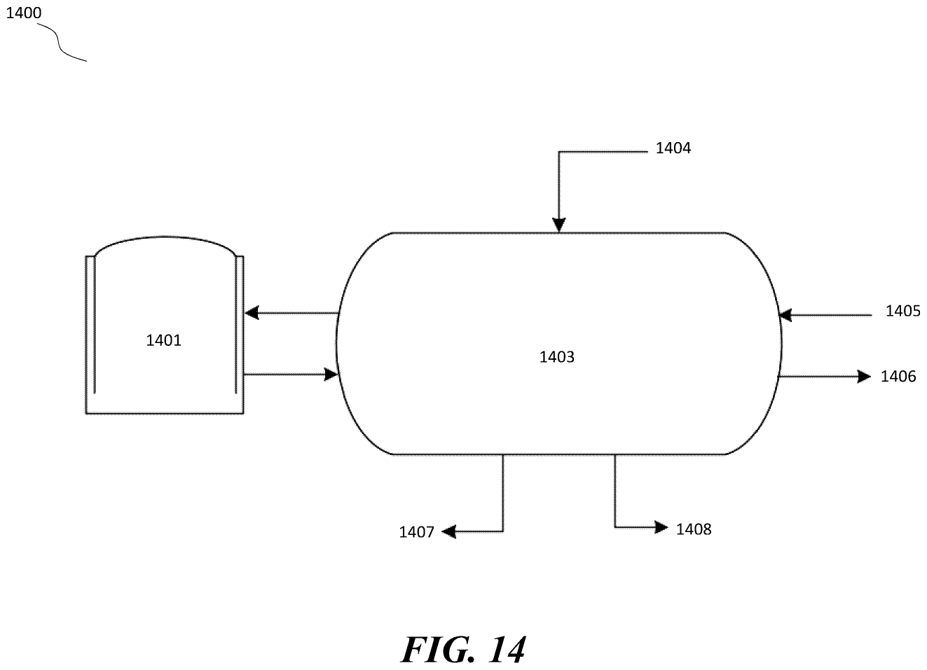

FIG. 14 is a flow diagram illustrating the process of heat utilization from a data center coupled with a liquid-driven multi-effect evaporation system 1400 according to some embodiments of the present disclosure. The system 1400 can include a heat source 1401 which can be a data center containing various (usually large) amounts of servers. For example, the heat source 1401 can include a data center rack. In some embodiments, the heat source stream can include an outlet heated dielectric coolant stream from the heat source 1401 that carries excess heat. The evaporation unit 1403 can include at least one falling film evaporator and one condenser. Moreover, the evaporation unit 1403 can include a feedwater distribution system and outlet freshwater and effluent streams. In some embodiments, the evaporation unit 1403 can include a plurality of falling film evaporators arranged in series, in parallel, or both, such as the arrangement described in FIGS. 7, 8, and 12. In particular, the evaporation unit 1403 can include an inlet coolant stream 1405 that can be fed to a condenser and an outlet coolant stream 1406. Moreover, the evaporation unit 1403 can include a concentrated feed outlet 1407 and a freshwater or distillate outlet stream 1408.

In some embodiments, the feedwater distribution system can regulate the flow of industrial wastewater, saline water, or hypersaline water into the evaporators within the evaporation unit 1403. In some embodiments, this can ensure an even distribution across the surface of the thermoplastic tubes within the various evaporators. In some embodiments, the feedwater stream can be all of or part of the heat sink flowing into the condenser or it can be independent of the heat sink stream. In some embodiments, the coolant stream 1405 can include seawater or groundwater.

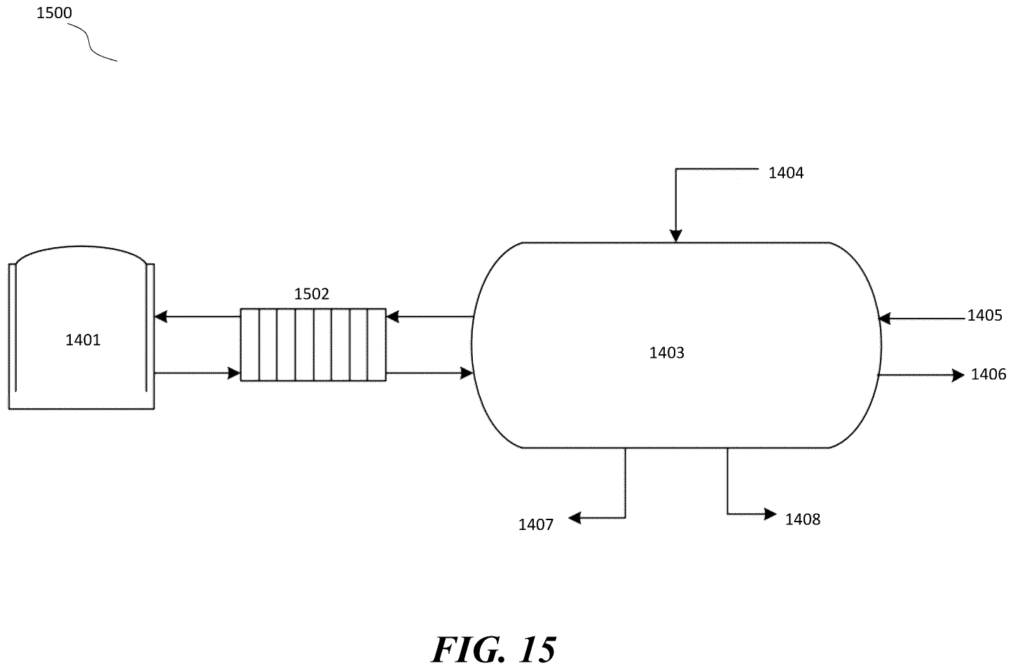

FIG. 15 is another flow diagram illustrating the process of heat utilization from a data center coupled with a liquid-driven multi-effect evaporation system 1500 according to some embodiments of the present disclosure. In some embodiments, the system 1500 can operate in a similar manner to the system 1400 of FIG. 14 except that the system 1500 also includes a heat exchanger 1502. The heat stream from the heat source 1401 can be connected to a heat exchanger 1502, which can be integrated with the heat source 1401 to capture and transfer waste heat to the evaporation unit 1403.

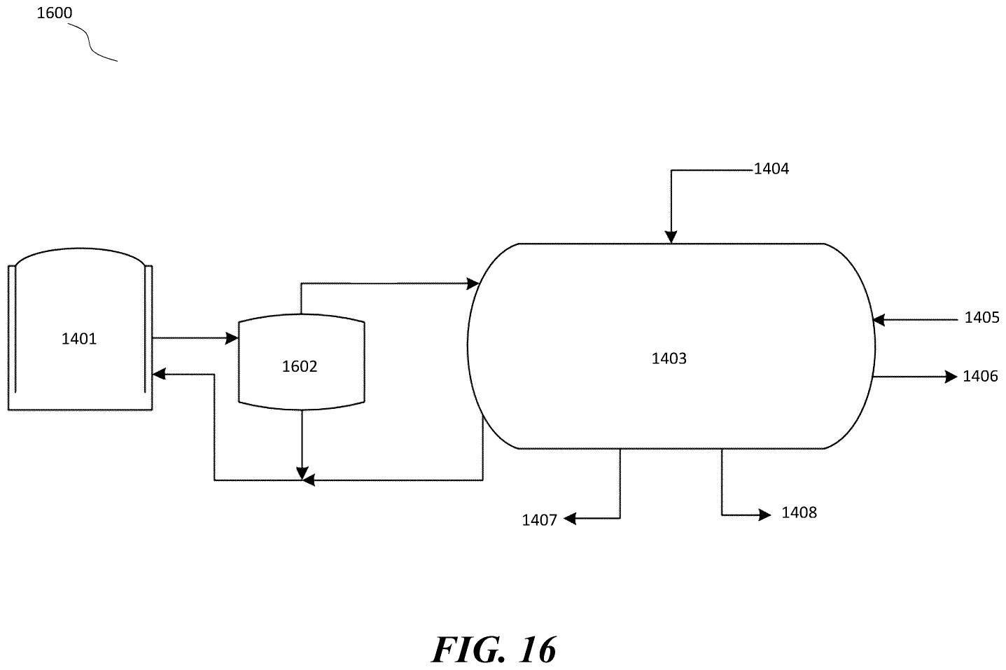

FIG. 16 is another flow diagram illustrating the process of heat utilization from a data center coupled with a steam-driven multi-effect evaporation system 1600 according to some embodiments of the present disclosure. In some embodiments, the system 1600 can operate in a similar manner to the system 1400 of FIG. 14 except that the system 1600 also includes a flash section 1602. The heat stream from the heat source 1401 can be connected to the flash section 1602, which can be integrated with the heat source 1401 to capture and transfer waste heat to the evaporation unit 1403. In this embodiment, a portion of the heat source stream evaporates in the flashing chamber 1602 and is used as a heat source for the first evaporator of 1403 which is the same as or similar to 300. The condensed heat source stream then exit from the first effect and will be mixed with the outlet liquid of the flash chamber and get back to 1401 in a closed cooling circuit.

In some embodiments, advantages of the system can include improvements to energy efficiencies. By utilizing waste heat, the system can significantly reduce the energy required for cooling the data center and treating wastewater. In addition, the system can reduce costs by lowering cooling costs for the data center and reducing operational costs for the wastewater treatment. In addition, the system can have a positive environmental impact by decreasing the environmental footprint of the data center and contributing to sustainable water management. Additionally, the system can allow for high-quality freshwater to be produced, such as boiler-grade freshwater suitable for various industrial applications. Finally, the system can be scalable to fit data centers of different sizes and different wastewater treatment requirements.

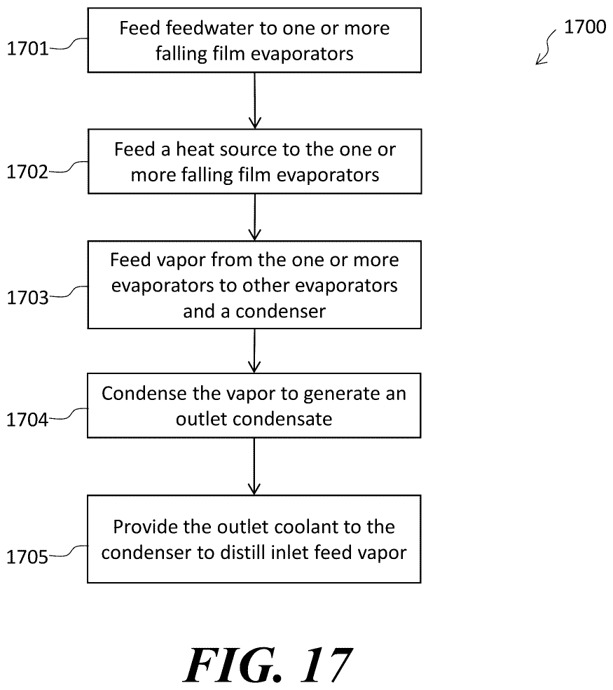

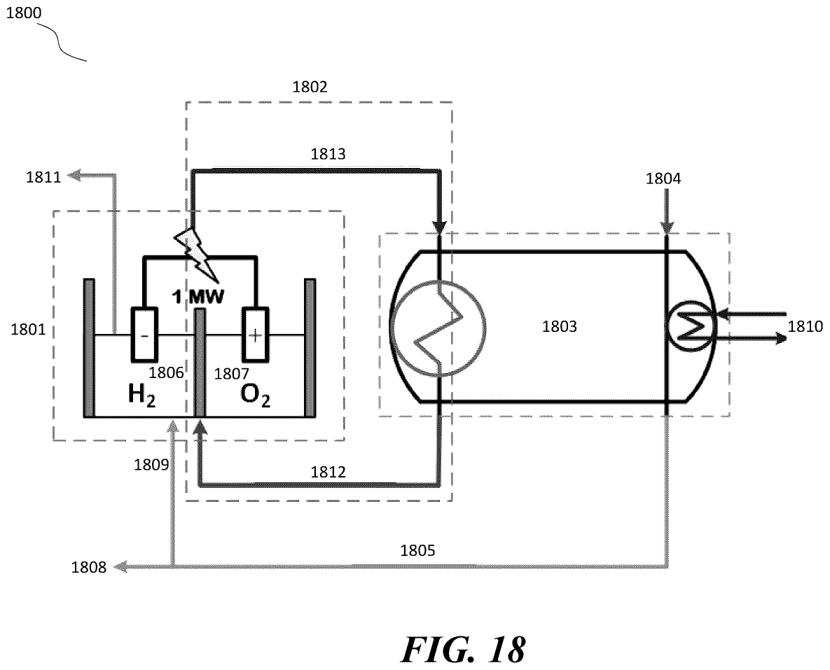

FIG. 17 is a flowchart showing an example process 1700 for utilizing waste heat for water treatment according to some embodiments of the present disclosure. The process 1700 can be performed using any of the various systems described herein, such as those of FIGS. 6-10, 12, 14-16, and 18. At block 1701, the process 1700 can include feeding feedwater to one or more falling film evaporators. In some embodiments the evaporators can be similar to or the same as those described herein, wherein they can include thermoplastic tubes and polymer composite plate sheets and vessels. In some embodiments, the one or more falling film evaporators can include a plurality of evaporators that can be arranged in series or in parallel or both. At block 1702, the process 1700 can include feeding a heat source to the one or more falling film evaporators. In some embodiments, as described in relation to FIGS. 12-16, the heat source can include a data center with various storage racks. In addition, in some embodiments, the heat source can include an electrolyzer as discussed in relation to FIG. 18 below or a fuel cell. In some embodiments, the heat source can be either hot liquid or steam/vapor. In some embodiments, prior to feeding the heat source to the one or more evaporators, the process 1700 can include feeding the heat source to a heat exchanger residing between the heat source (such as a data center, an electrolyser, a fuel cell or any other type of waste heat resources) and evaporators. In some embodiments, prior to feeding the heat source to the one or more evaporators, the process 1700 can include feeding the heat source to a flash chamber residing between the heat source (such as a data center, an electrolyser, a fuel cell or any other type of waste heat resources) and evaporators. In the embodiments where a flash chamber is used, the process 1700 can further include feeding an outlet coolant from the heat source (such as a data center, an electrolyser, a fuel cell or any other type of waste heat resources) to the flash chamber and feeding flashed vapor from the flash chamber to the one or more evaporators. In addition, a condensed stream outlet from the one or more evaporators can be mixed with an outlet liquid stream from the flash chamber.

At block 1703, the process 1700 can include feeding vapor from the one or more evaporators to other evaporators and condenser(s). At block 1704, the process 1700 can include condensing the vapor to generate an outlet condensate (generally as distilled water). At block 1705, the process 1700 can include providing the coolant for the last condenser or condensers to distil their inlet feed vapor. In case there is no coolant or heat sink available, a mechanical vapor compressor like the one shown in FIG. 10 is used to convert the last feed vapor into a heat source stream for the other evaporators.

Current technology can produce 1 kg of hydrogen out of 20 L of water, consuming around 70 kWh. However, due to the internal irreversibility of the process, around 30% of the input energy (21 kW) is wasted as heat. It's important to note that the numbers provided are approximations rounded for current technologies, and they may vary based on other factors such as the technology used, energy source, and water.

To produce a mole of hydrogen from a mole of liquid water at 25° C., it is necessary to supply 285.8 kJ of energy, with 237.2 kJ in the form of electricity and 48.6 kJ in the form of heat. This can be represented by the following equation: H2O(liquid)+237.2 KJ/mole(H2) electricity+48.6 KJ/mole(H2) heat→H2+½ O2.

In the metric system mass unit, 39.4 kWh of electrical energy is required to produce 1 kg of hydrogen. During this theoretical process, 83% of the energy is used for the separation process, while the remaining 17% is converted into heat. However, with current technology, it requires around 50 to 70 kWh of electrical energy to produce 1 kg of hydrogen, and up to 30% of the energy is converted into heat that must be continuously cooled down.

Although the waste heat generated by the electrolyser may seem like an inefficiency, it actually presents an opportunity to reuse this heat for other purposes. Currently, a 1 MW electrolyser can generate around 300 kW of waste heat. In this context our new system can use this waste heat to produce pure water from almost all types of saline and industrial wastewater.

Hydrogen electrolyzers (or fuel cells) produce a significant amount of waste heat during the electrolysis process. General methods used to dissipate this heat often involve energy-intensive cooling systems. At the same time, existing single- or multi-effect evaporation systems usually require substantial external energy inputs. By integrating these processes and utilizing the waste heat from hydrogen electrolyzers (or fuel cells), operational costs of the hydrogen plants can be significantly reduced. This is due to the elimination of standalone cooling systems and the improvement of water treatment processes, leading to enhanced sustainability. The combination of these technologies using the disclosed thermoplastic tubes can improve performance and be more cost-effective than conventional thermal evaporation processes.

Embodiments of the present disclosure relate to a multi-effect evaporation system that uses waste heat from hydrogen electrolyzers to treat various types of wastewater, including industrial, saline, and hypersaline water. The disclosed embodiments can use a series of falling film evaporators that employ thermoplastic tubes and polymer composite plate sheets to produce high-purity freshwater, thereby offering an energy-efficient solution for both electrolyzers cooling processes and wastewater treatment systems. The system is designed to provide cooling for electrolyzers while producing boiler-grade freshwater as a by-product. The disclosed system can produce high-quality boiler-grade water. Moreover, unlike reverse osmosis, the disclosed system has no feedwater-type limitations, making it possible to use almost any industrial process as a reliable water source for hydrogen plants.

The disclosed embodiments can also help reduce the size of cooling systems and minimize overall power consumption by integrating the cooling system and water generation processes. Furthermore, the disclosed embodiments can generate more freshwater than the electrolyzers require, effectively turning each hydrogen plant into a water generation system. This excess water can be sold as a by-product to other industries or used to supply other hydrogen plants, making it a profitable venture.

For instance, a 1 MW electrolyzer typically requires 5 to 10 m3/day of pure water and generates around 300 kW of waste heat. The disclosed embodiments are capable of producing more than four times the amount of water required by the electrolyzers, making it a highly efficient and sustainable solution.

In essence, the disclosed embodiments can convert each hydrogen electrolyzer facility into an industrial wastewater treatment and high-quality freshwater generation facility. This not only reduces CO2 emissions but also helps address the issue of industrial water pollution, making it a valuable and constructive contributor to local industrial sustainability.

FIG. 18 is a schematic representation of a system 1800 for utilizing waste heat from an electrolyzer for water treatment according to some embodiments of the present disclosure. The system 1800 can include an electrolyzer 1801 that can be used to generate hydrogen. For example, the electrolyzer 1801 can include a negative side 1806 and a positive side 1807 and can have a power value of about 1 MW. The main product output 1811 can be about 12-20 kgH₂/hr. In addition, the system 1800 can include a cooling section 1802, where a waste heat stream 1813 can flow from the electrolyzer 1801 to an evaporation section 1803. In some embodiments, the waste heat stream 1813 can be at approximately 300 kW and between 6° and 80° C., which can be about 30% of the electrolyzer capacity. In addition, the evaporation section 1803 can receive a feedwater source from 1804, which can be seawater, groundwater, hypersaline water, industrial wastewater, or others. Furthermore, the evaporation section 1803 can also be connected to a heat sink 1810 consistent with previous descriptions herein. Moreover, a cooled stream 1812 can be fed from the evaporation section 1803 back to the electrolyzer 1801. Finally, distilled freshwater 1805 can be fed from the evaporation section 1803 as a bi-product outlet 1808 and as an input 1809 back to the electrolyzer 1801. The system 1803 can be the same or similar to systems shown in FIGS. 6-8 and 12. Cooling system 1802 can include an intermediate heat exchanger(s) or flashing chamber(s), the same or similar to what is shown in FIGS. 15 and 16.

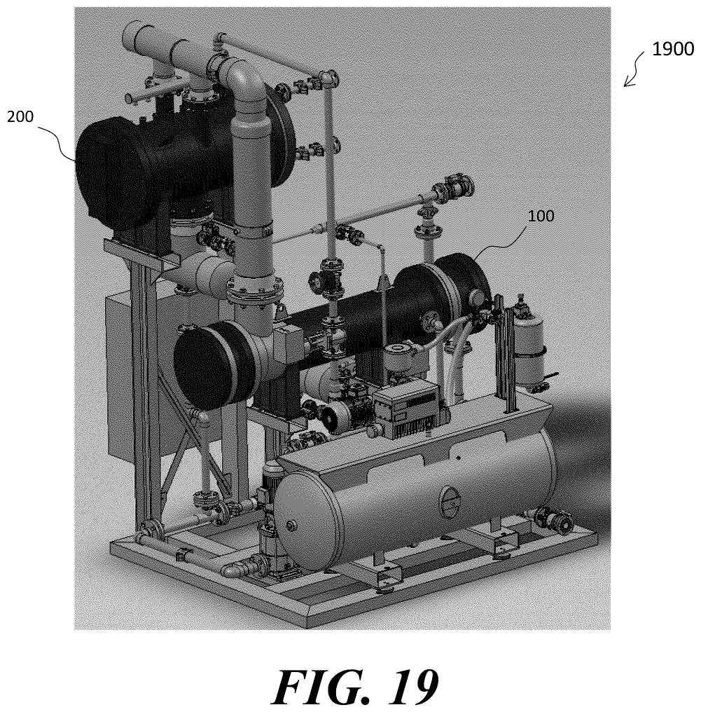

FIG. 19 is schematic of an example plant 1900 according to some embodiments of the present disclosure. In some embodiments, the plant 1900 can include a shell and tube condenser 100 and a falling film evaporator 200, consistent with the various embodiments described herein. In some embodiments, the plant 1900 can have a cooling capacity of about 42 kW and a freshwater production rate of approximately 1500 liters per day. In some embodiments, the embodiment disclosed in FIG. 19 can include a falling film evaporator 200 constructed from, for example, FRP, which can utilize the disclosed tubes. In addition, the embodiment can include a shell and tube condenser 100, which can be equipped with FRP and the disclosed tubes. In some embodiments, the system within FIG. 19 can be formed of plastic.

While various embodiments have been described above, it should be understood that they have been presented by way of example and not limitation. It will be apparent to persons skilled in the relevant art(s) that various changes in form and detail may be made therein without departing from the spirit and scope. In fact, after reading the above description, it will be apparent to one skilled in the relevant art(s) how to implement alternative embodiments. For example, other steps may be provided, or steps may be eliminated, from the described flows, and other components may be added to, or removed from, the described systems. Accordingly, other implementations are within the scope of the following claims. Also, different types of waste heat sources such as industrial waste heat streams or different equipment that produce waste heat such as fuel cells, wind turbine engine and solar panels can be coupled to the various embodiments have been described above.

In addition, it should be understood that any figures which highlight the functionality and advantages are presented for example purposes only. The disclosed methodology and system are each sufficiently flexible and configurable such that they may be utilized in ways other than that shown.

Although the term “at least one” may often be used in the specification, claims and drawings, the terms “a”, “an”, “the”, “said”, etc. also signify “at least one” or “the at least one” in the specification, claims and drawings.

Finally, it is the applicant's intent that only claims that include the express language “means for” or “step for” be interpreted under 35 U.S.C. 112 (f). Claims that do not expressly include the phrase “means for” or “step for” are not to be interpreted under 35 U.S.C. 112 (f).

1. A falling film evaporator comprising:
a shell comprised of a polymer composite material;
a first plate sheet connected to a first end of the shell comprising a first plurality of holes, each of the first plurality of holes comprising a grommet;
a second plate sheet connected to a second end of the shell comprising a second plurality of holes, each of the second plurality of holes comprising a grommet;
a tube bundle residing within the shell and comprising a plurality of thermoplastic tubes, each thermoplastic tube being connected to the first and second plate sheet via the respective grommets; and
an inlet configured to feed a heat source to the tube bundle that flows through the plurality of thermoplastic tubes.

2. The falling film evaporator of claim 1, wherein the grommets of the first and second plurality of holes are comprised of Ethylene-propylene diene monomer or Fluoroelastomers.

3. The falling film evaporator of claim 1, wherein each grommet has a thickness of at least 0.5 mm smaller than an outlet diameter of each of the thermoplastic tubes.

4. The falling film evaporator of claim 1, wherein the plurality of thermoplastic tubes is fabricated from heat-conductive polyphenylene sulfide, polypropylene, or a combination thereof.

5. The falling film evaporator of claim 1, wherein the shell is reinforced with at least one of fibers or filers.

6. The falling film evaporator of claim 1, wherein the shell comprises one or more exterior insulation layers.

7. The falling film evaporator of claim 1, wherein the heat source comprises a liquid.

8. The falling film evaporator of claim 7 comprising an outlet configured to feed the liquid heat source away from the evaporator.

9. The falling film evaporator of claim 1, wherein the heat source comprises steam.

10. The falling film evaporator of claim 9, wherein the steam exits the plurality of thermoplastic tubes as a condensate.

11. A shell and tube condenser comprising:
a shell comprised of a polymer composite material;
a first plate sheet connected to a first end of the shell comprising a first plurality of holes, each of the first plurality of holes comprising a grommet;
a second plate sheet connected to a second end of the shell comprising a second plurality of holes, each of the second plurality of holes comprising a grommet;
a tube bundle residing within the shell and comprising a plurality of thermoplastic tubes, each thermoplastic tube being connected to the first and second plate sheet via the respective grommets; and
an inlet configured to feed a refrigerant to the tube bundle that flows through the plurality of thermoplastic tubes.

12. The shell and tube condenser of claim 11, wherein the grommets of the first and second plurality of holes are comprised of Ethylene-propylene diene monomer or Fluoroelastomers.

13. The shell and tube condenser of claim 11, wherein each grommet has a thickness of at least 0.5 mm smaller than an outlet diameter of each of the thermoplastic tubes.

14. The shell and tube condenser of claim 11, wherein the plurality of thermoplastic tubes is fabricated from heat-conductive polyphenylene sulfide, polypropylene, or a combination thereof.

15. The shell and tube condenser of claim 11, wherein the shell is reinforced with at least one of fibers or filers.

16. The shell and tube condenser of claim 11, wherein the shell comprises one or more exterior insulation layers.

17. A falling film evaporator comprising:
a shell comprised of a polymer composite material;
a first plate sheet connected to a first end of the shell comprising a first plurality of holes, each of the first plurality of holes comprising a grommet;
a second plate sheet connected to a second end of the shell comprising a second plurality of holes, each of the second plurality of holes comprising a grommet;
a tube bundle residing within the shell and comprising a plurality of thermoplastic tubes, each thermoplastic tube being connected to the first and second plate sheet via the respective grommets; and
an inlet configured to feed feedwater to the tube bundle that flows through the plurality of thermoplastic tubes.

18. The falling film evaporator of claim 17, wherein the grommets of the first and second plurality of holes are comprised of Ethylene-propylene diene monomer or Fluoroelastomers.

19. The falling film evaporator of claim 17, wherein each grommet has a thickness of at least 0.5 mm smaller than an outlet diameter of each of the thermoplastic tubes.

20. The falling film evaporator of claim 17, wherein the plurality of thermoplastic tubes is fabricated from heat-conductive polyphenylene sulfide, polypropylene, or a combination thereof.
